(19) United States
(12) Patent Application Publication
(10) Pub. No.: US 2013/0191399 A1
(43) Pub. Date: Jul. 25, 2013

(54) System and Method for Content Distribution

(71) Applicants: William Tocaben, Ashville, NC (US); Gabriel Scotto, Brooklyn, NY (US)

(72) Inventors: William Tocaben, Ashville, NC (US); Gabriel Scotto, Brooklyn, NY (US)

(21) Appl. No.: 13/747,259

(22) Filed: Jan. 22, 2013

Related U.S. Application Data
(60) Provisional application No. 61/589,595, filed on Jan. 23, 2012.

(51) Int. Cl. G06F 17/30

(52) U.S. Cl. CPC G06F 17/3053
USPC 707/748

(57) ABSTRACT

A system and method that selects content data from a set of content data for broadcast is provided. The system includes a content database that stores the set of content data therein, the set of content data including a plurality of content data files, each of the respective content data files being provided by a respective user. A communication interface receives ranking data from users for content data files within the set of content data. A control processor is coupled to the communication interface and generates an aggregate content rank for each of the content data files based on the ranking data received by the communication interface and selects a subset of content data files from the content database having the greatest aggregate content rank for inclusion in a broadcast playlist. A broadcaster broadcasts the subset of content data files in the broadcast playlist based on the aggregate content rank.

### CROSS REFERENCE TO RELATED APPLICATIONS

This nonprovisional patent application claims priority U.S. Provisional Patent Application Ser. No. 61/589,595 filed on Jan. 23, 2012 by William Tocaben and Gabriel Scotto.

### FIELD OF THE INVENTION

The invention concerns a system and method that provides an interactive community of users that selectively determines and controls the content being broadcast to users of the community and outside the community.

### BACKGROUND OF THE INVENTION

Conventional content control and distribution systems provide the user with the ability to selectively determine the type and order of content to be consumed by the particular user. This is known as generating a playlist and provides the user with the ability to customize the content being consumed by the user. Additionally, there are systems that enable sharing of user-created playlists whereby the creating user allows other users to view and even listen to the content contained in the user-specific playlist. Typically, the systems that allow a user to share user-created playlists are web-based systems and connect users over the internet to form a community of users. Further systems exist that allow users to comment on or otherwise rank user-created playlists using these web-based systems. However, a drawback associated with these systems is the requirement that the user participate in the same interactive community and that sharing of user created lists of content only occurs within these particular online communities. Thus, a further drawback of these systems is the inability for users to share content outside of the community to share content with non-community members using a distribution mechanism that does not require membership within a community.

Although, conventional website technology provides independent artists with avenues to add their works for public exposure, the focus has been on serving fragmented and individual listeners and not filtering these works to generate mass broadcast. Mass broadcast, as in traditional radio, remains the best way to provide maximum exposure and effectively promotion of a work by providing a communal consumption experience. A conflict exists between internet based media sites which are concerned with serving media in as personalized a way as possible and broadcasters which distribute music in a traditional manner. This may include radio stations, in conjunction with the record industry and disc jockeys, editorially playing music over a particular radio frequency for receipt by a user. While the traditional broadcast model may work well for established artists, independent artists have difficulty gaining access to traditional broadcast and rely instead on the fragmented Internet sector for exposure. The result is independent artists are unable to be included within a regular broadcast rotation. In order to avail themselves of a regular broadcast rotation, independent artists, working without the Power of the large record labels, must pay promotion and publicity services in order to get massive exposure.

Therefore, a need exists to provide a system that enables users to submit user created content to a plurality of users within a community and control the distribution of the user created content to members both within the community as well as to users that are not members of the community using a content distribution mechanism. A system and method according to invention principles addresses these deficiencies and related problems.

### SUMMARY OF THE INVENTION

A system and method for distributing content created by users who do not otherwise have a venue for distributing content is provided. An interactive web-accessible system gathers media content from content creators and filters the content to identify a subset of content that is determined, by the users, to be included in a broadcast rotation for a content delivery platform. The filtering employed to determine the content to be included in a broadcast rotation is based on user activity and user ratings. User activity data is monitored by the system and employed in determining the content to be included in a broadcast rotation.

In one embodiment, a system that selects content data from a set of content data for broadcast is provided. The system includes a content database that stores the set of content data therein, the set of content data including a plurality of content data files, each of the respective content data files being provided by a respective user. A communication interface receives ranking data from users for content data files within the set of content data. A control processor is coupled to the communication interface and generates an aggregate content rank for each of the content data files based on the ranking data received by the communication interface and selects a subset of content data files from the content database having the greatest aggregate content rank for inclusion in a broadcast playlist. A broadcaster broadcasts the subset of content data files in the broadcast playlist based on the aggregate content rank.

In another embodiment, a method of selecting content data from a set of content data for broadcast is provided. The method includes the activities of storing, in a content database, a plurality of content data files as a set of content data files, each of the respective content data files being provided by a respective user and receiving, via a communication interface, ranking data from users for content data files within the set of content data. The method further includes generating, via a control processor, an aggregate content rank for each of the content data files based on the ranking data received by the communication interface and selecting a subset of content data files from the content database having the greatest aggregate content rank for inclusion in a broadcast playlist. The subset of content data files in the broadcast playlist is broadcast based on the aggregate content rank.

### BRIEF DESCRIPTION OF THE DRAWING FIGURES

FIG. 1 is a block diagram of the content distribution system according to invention principles;

FIGS. 2-15 are exemplary screen shots of the various display images generated by the content distribution system according to invention principles; and

FIG. 16 is a flow diagram detailing operation of the content distribution system according to invention principles.

### DETAILED DESCRIPTION

An executable application, as used herein, comprises code or machine readable instructions for conditioning a processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A processor as used herein is a hardware device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between.

A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and method according to invention principles provides an interactive online community that allows different types of users who are fans of a particular type of content to interact with one another. Community users may include content creators who create the content and content consumers who are users that are fans of the content created by content creators. In one embodiment, the type of content is audio content that is created by at least one content creator (e.g. musician, artist, etc) within the community and the content consumer may be fans of at least one content creator. In another embodiment, the content creators are artists who do not have a distribution deal or agreement with a record label and thus are classified as independent artists or independent content creators. Thus the system advantageously enables provides independent content creators with a platform to distribute their content for consumption by other content creators and consumers.

The interactive community advantageously enables creation of at least one of an interactive broadcast and narrowcast using a plurality of different types of content distribution platforms. In one embodiment, the system collects audio content (e.g. at least one song) from content creators and the different types of content distribution platforms include at least one of (a) a terrestrial radio station broadcast and (b) digital online distribution via a communications network (e.g. internet radio). The system further advantageously enables interactive and dynamic filtering of content created by users and the distribution thereof. The interactive and dynamic filtering enabled by the system generates ranking values associated with respective pieces of content created by users which are stored within a content database. The ranking values are generated by users within the interactive community and are directly used by the system to automatically generate a distribution list through which the user-ranked content is distributed via at least one type of content distribution platform. In one embodiment, the content having the highest ranking value is automatically selected by the system for distribution via one of (a) terrestrial radio broadcast; (b) a narrowcasting player; (c) a Digital Radio Stream; and (d) a Website.

Thus, in one embodiment, the system advantageously provides a platform for artists to submit music they created and provide them with an avenue to have their music played on a wide scale distribution network such as terrestrial radio. In this manner, the system advantageously integrates a user submission policy and radio playlist generation to provide broad-based exposure for the artist by allowing their music to be played on a terrestrial radio station and reach users that may not be members of the interactive online community. The interactive community provides a form of peer review of an artist's music and automatically selects a set of the most popular songs during a given time frame for play over a terrestrial radio broadcast. The popularity of songs is advantageously determined by user ratings provided by users that are at least one of artists and fans to determine which songs will move into rotation for the terrestrial radio broadcast. Thus, the system advantageously enables user ratings and rankings to directly influence and control a set of music that will be broadcasted over a terrestrial radio station. Moreover, each song submitted by a user and selected via user ranking for terrestrial radio broadcast is associated with an artist profile page. The artist profile page, in addition to facilitating artist submission of music, provides a comprehensive set of information that is associated with the artist and which is presented to the fan user to enable the fan to seek other music by the same artist and music by other artists that create similarly styled music. In one embodiment, only users of the interactive community that are fans may rank and filter artist created content to determine the content that will be put into a rotational database of songs to be broadcasted by a terrestrial radio station. In another embodiment, both artists and fans may rank artist created content to determine the content that will be put into a rotational database of songs to be broadcasted by a terrestrial radio station. In a further embodiment, both artists and fans may rank artist created content to determine the content that will be put into a rotational database of songs to be broadcasted by a terrestrial radio station and the ranking value associated with each song is determined according to a weighted value applied to the type of user who submits rating information. This may allow for ratings of fans to be counted more than ratings of artists when determining which songs will be automatically included into the rotational database for broadcast via a terrestrial radio station. The distribution platform being a terrestrial radio station is intended to mean broadcasting over FM and/or AM radio as well as digital broadcasts over a communication network such as the internet. The following figures describe one or more embodiment of the present system according to invention principles.

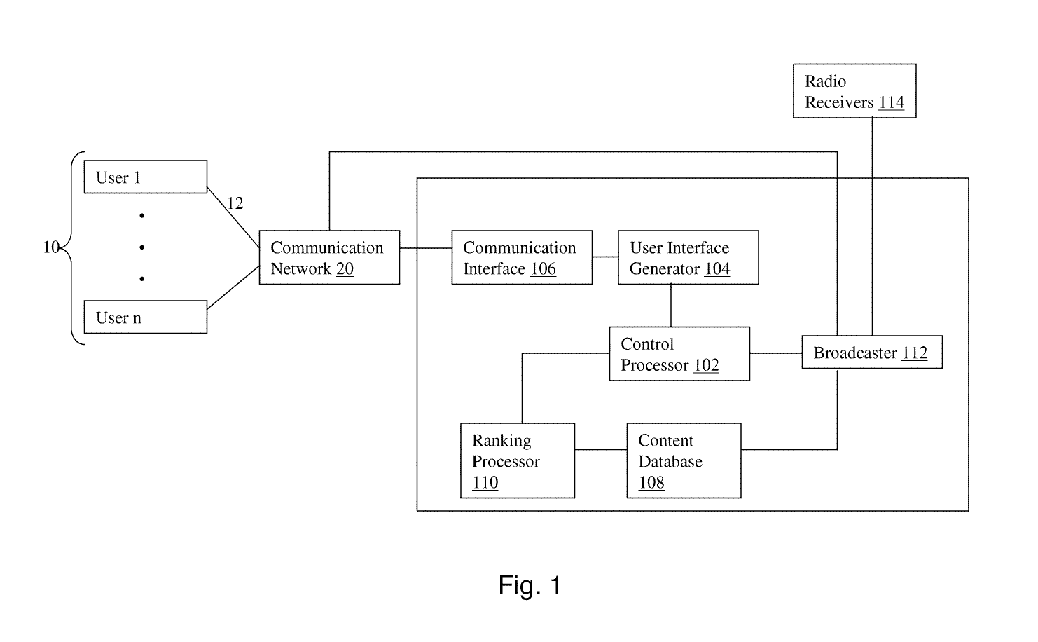

FIG. 1 is a block diagram of the content distribution system 100 according to invention principles. The content distribution system 100 is selectively accessible by a plurality of user devices 10 via a communication network 20. The plurality of user devices 10 may include at least one of (a) a personal computer; (b) a mobile communication device; (c) a Smartphone; (d) a tablet computing device; and (e) an internet connected terminal. The communication network 20 may be at least one of (a) a wide area communication network; (b) a local area network; and (c) the internet. The communication network 20 may enable user devices 10 to communicate using any of wired or wireless communication protocols. Additionally, the communication network 20 may include a more than one type of communication network such as a cellular network and a communication network that employs TCPIP communication protocols. The description of the types of communication network 20 is described for purposes of example only and any communication network employing any communication protocol that interconnects a plurality of user devices 10 with the content distribution system 100 may be used.

The user devices may be selectively controlled by a user input device to selectively communicate data requests 12 via the communication network 20. The user input device may include at least one of (a) a keyboard; (b) a mouse; (c) a touch screen; (d) a stylus; and (e) voice recognition module able to selectively listen to and translate user voice commands into data. The data requests 12 are communicated over the communication network 20 and received by the content distribution system 100 in the following manner.

The content distribution system 100 includes a control processor 102 the selectively executes at least one executable application that controls operation of the system 100. A user interface generator 104 is electrically coupled to the control processor 102 and automatically generates at least one display image that enables user interaction with the system 100. The at least one display image is generated in response to instructions received from the control processor 102. A communication interface 106 is coupled to the user interface generator 104 and selectively enables bidirectional communication via the communication network 20 between the user devices 10 and the system 100. The communication interface 106 may be a web server that selectively provides a location on the communication network 20 that allows the user devices 10 to access the system 100 in a known manner. Data representing the at least one display image generated by the user interface generator 104 may be provided to the communication interface 106 which allows the user devices 10 to interact with the content distribution system 100.

The content distribution system 100 may also include a content database 108. The content database 108 may be a relational database and be able to store at least one of (a) user account data; (b) artist information data; (c) content and (d) content ranking data. In one embodiment, content may include an audio data file encoded using an audio codec that enables the audio file to be transmitted across the communication network 20. Thus, the content database may also include a storage medium for storing content data as well as relational information about the content data stored therein. The audio data file may be formatted in any of audio format including but not limited to (a) mp3 format; (b) aac format; (c) mp4 format; (d) wma format; and (e) flac format. The system may selectively receive user-submitted content data representing at least one type of content (e.g. audio data) from at least one user device 10. The user-submitted content originating from at least one user device 10 and communicated via the communication network 20 is received by the communication interface 106. The control processor 102 automatically recognizes the type of data being received by the communication interface 106 as content data and causes the received content data to be stored in the content database 108.

The content distribution system 100 further includes a ranking processor 110 coupled between the control processor 102 and the content database 108. The ranking processor 110 executes a ranking algorithm that enables users of the content distribution system to rank content submitted by other users to determine a subset of content stored in the content database 108 that will be broadcasted via a broadcaster 112. The ranking algorithm is employed during a predetermined time period and allows a particular user to rank a particular piece of content once during the predetermined time period. In one embodiment, the broadcaster 112 is terrestrial radio broadcast apparatus that distributes content to users on a particular radio frequency and which is received by at least one radio receiver 114. The ranking algorithm executed by the ranking processor 110 enables each piece of content stored in the content database 108 to be ranked using a primary ranking criteria. A user may only assign a primary rank value once during the predetermined time period. In one embodiment, the primary ranking criteria may be a numerical scaled rank value that is selectively entered by the user within one of the display images generated by user interface generator 104. For example, a display image may be generated by the user interface generator 104 and communicated using the communication interface 106 over communication network 20 for receipt and display on at least one user device. This user interface display image may include a section displaying an image representative of a piece of content stored in the content database 108 in conjunction with content information associated with the stored content. Content information may include at least one of (a) artist information; (b) content description information; (c) an identifier enabling link access to additional information about the content; and (d) content history information. Content history information may provide a user with information identifying a duration that the content has been stored in the content database 108 and information identifying a number of times the content has been played both using the interactive community player as well a number of times the song has been broadcast by the broadcaster 112. A ranking image element may also be presented within the display image. The ranking image element enables a user to selectively rank the piece of content. Selection of a particular image element within the ranking image element automatically generates a rank value that is used as part of the primary ranking criteria for the particular piece of content. In one embodiment, the ranking image may be a predetermined number of user-selectable image elements displayed as stars. The image elements may be selectable via input received from a user input device coupled to the user device 10. Selecting a respective number of stars assigns a numerical rank value to the content and is used as the primary ranking criteria for the content. The ranking processor 110 automatically aggregates the numerical rank values for the particular piece of content that were entered by a plurality of users within a predetermined time period to generate an aggregate content rank value.

This aggregation occurs for each piece of content that is stored in the content database 108 and that was ranked by a plurality of users. The rank processor 110 uses the aggregate rank value to automatically determine which pieces of content are rated the highest for the predetermined time period. The rank processor 110 generates data representing the highest rank pieces of content for the particular time period and provides the ranking data to the control processor 102. The control processor 102 may automatically cause the broadcaster 112 to update a broadcast playlist to include the highest ranked content which is stored in the content database 108. In one embodiment, the control processor 102 causes data stored in the content database 108 corresponding to the highest rank content to be transferred to the broadcaster 112 for broadcasting thereof. In another embodiment, the control processor 102 may selectively provide a message including a plurality of links identifying a location within the content database 108 where the highest rank content is stored enabling access thereto. Thus, the content being broadcasted by broadcaster 112 is automatically and directly determined by users of the content distribution system.

In another embodiment, the aggregate rank value is determined using a secondary ranking criteria in addition to the primary ranking criteria. The secondary ranking criteria may be a content point value that is selectively incremented based on an interaction between the user and the particular piece of content. Upon storage within the content database 108, each piece of content may be assigned a base content point value for the secondary ranking criteria. The base content point value for each piece of content may be stored in a record of the content database 108. Any interaction between a user and a particular piece of content may be assigned an interaction point value and, upon a user interacting with the content in the particular manner, the base point value for the content is incremented by a number corresponding to the interaction point value. Exemplary interactions may include at least one of (a) rating the content; (b) marking a content as favorite; (c) sharing the content with at least one other user; (d) sharing the content on a social networking site; (e) linking to the content on a page accessible to other users; (f) purchases the content; and (g) comments on the content. These interactions are described for purposes of example only and any action taken by a user with respect to a piece of content may be assigned an interaction point value. Each interaction may have the same point value associated therewith or different point values such that certain interactions result in a higher point value than others. Unlike the primary rank criteria, the secondary ranking criteria may be continually updated based on user interaction during the predetermined time period.

Upon a user interacting with the content in a manner having interaction point value associated therewith, the control processor 102 automatically increments the base point value in the record using the interaction point value. The content point value may be incremented any number of times within the predetermined time period and is based on the types of interaction of different users. At the conclusion of the predetermined period, the ranking processor 110 queries the content database to determine the content point value for each piece of content and, in conjunction with the aggregate rank value determined using the primary ranking criteria, determines a combined rank value for each piece of content. The rank processor 110 generates data representing the highest rank pieces of content for the particular time period based on the combined rank value and provides the ranking data to the control processor 102. The control processor 102 may automatically cause the broadcaster 112 to update a broadcast playlist to include the highest ranked content based on the combined rank value which is stored in the content database 108 in the manner discussed above.

In another embodiment, the content point value may be decremented by an interaction point value that corresponds to a negative interaction between the user and the content. Exemplary negative interactions may include at least one of (a) decreasing a previously entered rating associated with the content; (b) removing the content from a favorites list; (c) unlinking content from a page accessible to other users; and (d) providing a negative comment about the content. Upon a user interacting with the content in a negative manner having a negative interaction point value associated therewith, the control processor 102 automatically decrements the content point value in the record using the negative interaction point value.

The predetermined time period during which the ranking processor 110 determines the aggregate or combined rank values for pieces of content may be at least one of (a) daily; (b) weekly; (c) monthly and (d) yearly. In another embodiment, the ranking processor 110 may execute a ranking algorithm for a plurality of different time periods to determine trend data for pieces of content. This may be performed in a similar manner as discussed above with respect to using the primary and secondary ranking criteria for the different time periods. The ranking processor 110 may automatically combine rank values determined over different time periods to further directly control the broadcaster 112 to broadcast a particular set of content for a given time.

In operation, the content that is provided to the broadcaster is determined by averaging all of the rank values associated with a particular piece of content. The average may be taken to a predetermined number of decimal places in order to minimize the number of pieces of content having the same rank value. To distinguish between content having the same rank value as determined by the primary rank criteria, the secondary rank criteria may be employed to user the interaction point values associated with the content to further separate and rank content.

The rank processor 110 may also employ a quality filter that selectively determines which songs may be eligible to be ranked and submitted as part of the broadcast rotation. In another embodiment, the rank processor 110 may also employ the quality filter to selectively determine the composition of a playlist that may be played for a user. The quality filter employed by the rank processor 110 may include at least one predetermined filter parameter controlling whether or not the content, should it be ranked high among other pieces of content, be submitted in a playlist provided for broadcast rotation. In one embodiment, the filter parameter represents a number of times a particular piece of content has been rated. If the content has not been rated a predetermined number of times, the particular piece of content will not be included in the determination of content rank value by the rank processor 110. Employing this filter parameter prevents a skewed result that may occur if content only has few ratings resulting in the content being artificially determined as having a high rank or a low rank. In another embodiment, the filter parameter may represent a gate percentage whereby only content above a certain percentage in rankings may be used in the rank value determination made by the rank processor 110. For example, a setting of 90% only allows the top 90% of ranked songs to be included within the rank value determination.

At the conclusion of each predetermined time period, a list of content having the highest content rank values is generated from the content database 108 and provided to the control processor 102. The list may include any number of highly ranked pieces of content. In one embodiment, the list includes the ten pieces of content having the highest rank value associated therewith for a given time period. The content contained in the list is identified and checked to ensure compliance with any regulations associated with broadcasting content via a terrestrial radio station (e.g. FCC compliance). Because of the need to check FCC regulatory compliance (e.g., obscenity) content on the list are reviewed for FCC compliance and any content that does not comply is automatically removed from the list and replaced with the a piece of content having the next highest rank value. The vetted list of content is automatically provided to the broadcaster 112 which may execute a broadcast rotation algorithm controlling the content being broadcasted thereby. The broadcast rotation algorithm is updated with the content contained in the list and applies a high rotational weight to the content on the list. Upon updating of the broadcast rotation algorithm to include the highest ranked content from the predetermined time period, the rotational weight associated with content that was on previous content lists from prior time periods is modified to reflect a conventional broadcast rotation level. However, the previously identified highly ranked pieces of content remain within the broadcast rotation thereby rewards the artists with continued broad exposure of their content. However, the current highly ranked content from the current predetermined period are provided with a greater play weight and are played more frequently that other pieces of content contained in the broadcast rotation.

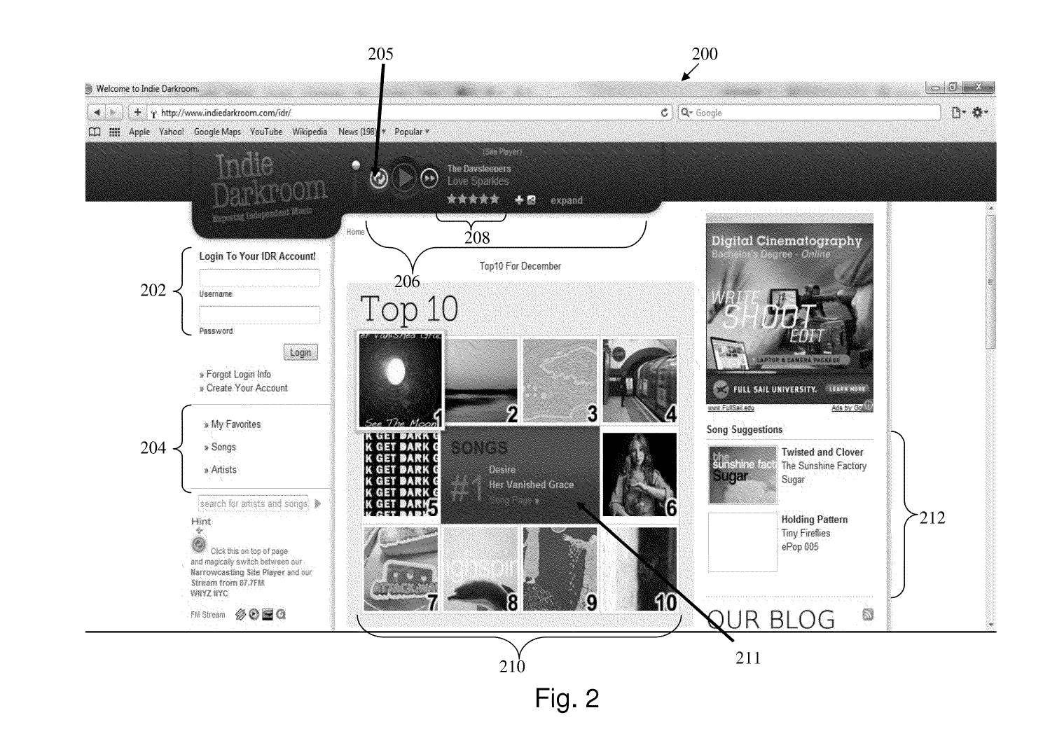

The content distribution system 110 advantageously generates a plurality of display images that represent an online interactive community in which independent artists (e.g. artists who do not have an agreement of any type with a major record label) and fans can interact with one another. The interactive community advantageously provides the artists with a platform for distributing their content while providing fans with exposure to content that would otherwise not be available. The interactive community further provides the advantage of enabling fans to interactively and dynamically filter content that will be broadcast via a terrestrial radio station thereby providing the independent artists with exposure to users outside of the interactive community. Exemplary user interface display images generated by the user interface generator 104 in response to instructions provided by the control processor 102 that enable user interaction with the system will be described hereinafter with respect to FIGS. 2-16

The control processor 102 may execute computer executable instructions to generate at least one display image representing a home page for an interactive community that may be selectively accessible by a plurality of users. An exemplary homepage display image 200 is shown in FIG. 2. The homepage 200 includes a log in section 202 including user fillable fields corresponding the user name and password. By entering a user name and password in the log in section 202, the control processor 102 authenticates the user-entered information and selectively grants or denies access to the interactive community. The homepage 200 further includes user-specific content information in section 204. User specific content information may include information identifying a set of content selected from all content stored in the content database 108 that the user designates as “favorite”. Additional user specific content information may include at least one of (a) songs and (b) albums that the user has either provided to the interactive community or reviewed/accessed while interacting with other users of the interactive community.

The homepage 200 may also include a community information section 210 that selectively display information about the interactive community. In the embodiment shown in FIG. 2, community information section 210 includes an image representing a set of content having the highest rank value associated therewith. The image may be a single image having a plurality of selectable sections that enable a user to access the content corresponding thereto by selection thereof. Alternatively, the community information section 210 may be comprised of a plurality of user selectable image elements individually corresponding to a particular piece of content determined to have the highest rank value for the particular time period. The community information section 210 may include a sub-display element 211 that provides an enhanced set of information associated with a selected piece of content. The enhanced set of information may include any of (a) content title; (b) album title; and (c) a link enabling access to a user page for the selected content.

The home page 200 further includes a content player section 206 that selectively plays content stored in the content database 108 for the user. The control processor 102 uses a set of user-entered content preferences to automatically select content from the content database 108 that match at least one user entered content preference. Thus, the content player section 206 allows a user to audibly sample a plurality of different types of content submitted by different users. The content player section 206 further includes the ranking image element 208. As the user samples the content, the user may selectively determine and enter a rank for the particular content using the ranking image element 208. The ranking element 208 may include a plurality of user selectable stars that will associate a numerical rank value with the particular content. Selection of the left most star results in a rank value of 1 which is the lowest rank value. The rank values increase from left to right. In one embodiment, the rank values may be 1 through 5. In another embodiment, the rank values may increase exponentially as each star is selected.

The content player section 206 is automatically displayed within each display image generated by the content distribution system thereby advantageously continuously providing content to the user enabling the user to selectively sample and rank content provided by other users.

In addition to being present within the content player section 208, the ranking image element 208 may also be present on particular display images associated with each piece of content stored in the content database 108. This further enables the user to rank content at a plurality of different times. For example, if one user recommends content to a second user, the second user may selectively access a content page associated with the recommended content and automatically be provided with a ranking image element 208 that allow the user to selectively rank the recommended content.

The content player section 206 may include a content source selector 205. The content source selector 205 selectively controls the source of content being played by the content player section 206. A first source for the content player is content stored in the content database 108. Upon selection of the content source selector 205, the control processor 102 automatically switches the content source from the content database 108 to the broadcaster 112. Thus, the user is presented with a live broadcasted content comprising content determined by the users of the community which is being broadcast via the terrestrial radio station. The ranking image element 206 is displayed despite the source and advantageously enables the user to rank the live-broadcasted content in a similar manner as described above with respect to the content stored in the content database 108.

The home page 200 may also include a community recommendation section 212 that includes data representing at least one piece of content that is recommended for the particular user. The content appearing in the recommendation section may include any of (a) content that matches at least one user specified preference; (b) content that has been sampled by other users having at least one user preference in common with the user: and (c) content that has been newly added by another user. The recommended content data displayed in section 212 may be user selectable image elements that, upon selection by a user, enable the user to at least one of access information associated with the content and play the content using the content player 206.

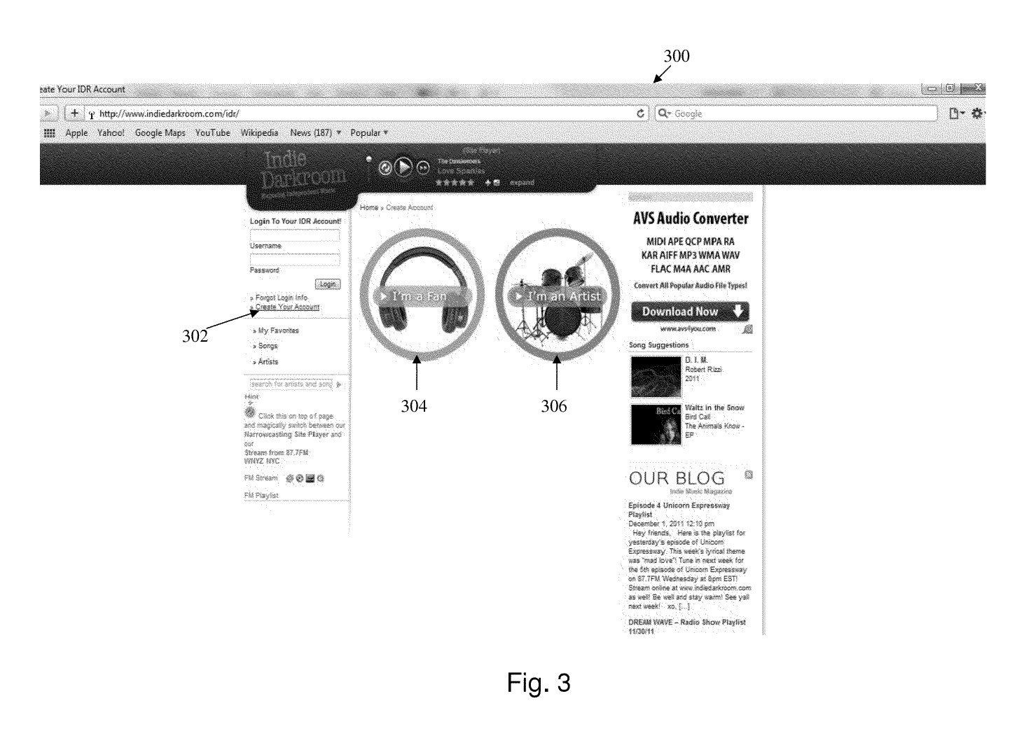

In one embodiment, the control processor 102 causes the interface generator 104 to generate a display image 300 enabling a user to create an account to access the content distribution system as shown in FIG. 3. The account creation display image 300 includes first account type image element 304 and a second account type image element 306. In one embodiment, the first account type image element 304 is a fan account type image element and the second account type image element 306 is an artist account type image element. Selection of a respective account type image element 304 and 306 enables execution of an account creation algorithm by the control processor 102. Selection of the fan account image element 304 allows a user to identify them as a fan and general user of the interactive community of the content distribution system 100.

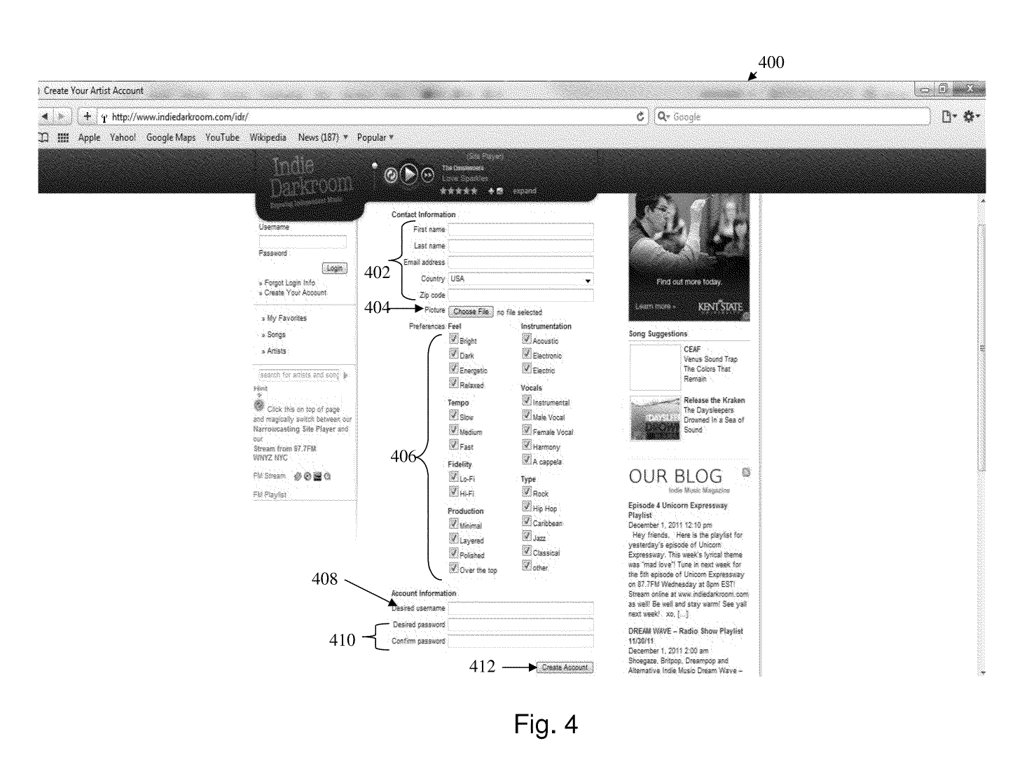

The display image shown in FIG. 4 is generated by the user interface generator 104 (FIG. 1) in response to the user account creation algorithm executed by the control processor 102 (FIG. 1). FIG. 4 is an exemplary fan account creation display image 400. The creation of a fan account requires a predetermined set of information associated with the user and which is entered via a plurality of user fillable data fields 402. The set of information associated with the user required to establish a fan account with the content distribution system 100 may include first and last name of a user, a valid email address, and zip code. The display image 400 also includes a content characteristic selection section 406 that includes at least one characteristic describing content that the user finds appealing. Each of the at least one content characteristic may include at least one content descriptor providing information describing the content characteristic. A user may select from a predetermined listing of content descriptors to identify types of content that the user would like to listen to. Upon selection of the content descriptors associated with particular content characteristics, the control processor 102 automatically generates user preference data associated with the particular user and stores the user preference data in the content database 108 and links the user preference data with a record corresponding to the particular user. In another embodiment, the in addition to a predetermined candidate list of content descriptors, the display image may provide a user fillable data field enabling the user to input data representing a content descriptor for use in identifying content that might be appealing to a user. For example, in the instance that the content is audio content created by at least one artist, the content characteristics may include at least one of (a) feel of the music; (b) instrumentation in the music; (c) tempo of the music; (d) vocal characteristics of the music; (e) fidelity of the music; (f) type/genre of the music; and (g) production value of the music. Exemplary user-selectable content descriptors associated with respective content characteristics are shown in section 406 in FIG. 4. It should be noted that the content characteristics and respective content descriptors are provided for purposes of example only and the system may be configured to include any content characteristic having any type of content descriptor for selection by a user which will be used to determine a selection of content to be provided to the user for listening and ranking.

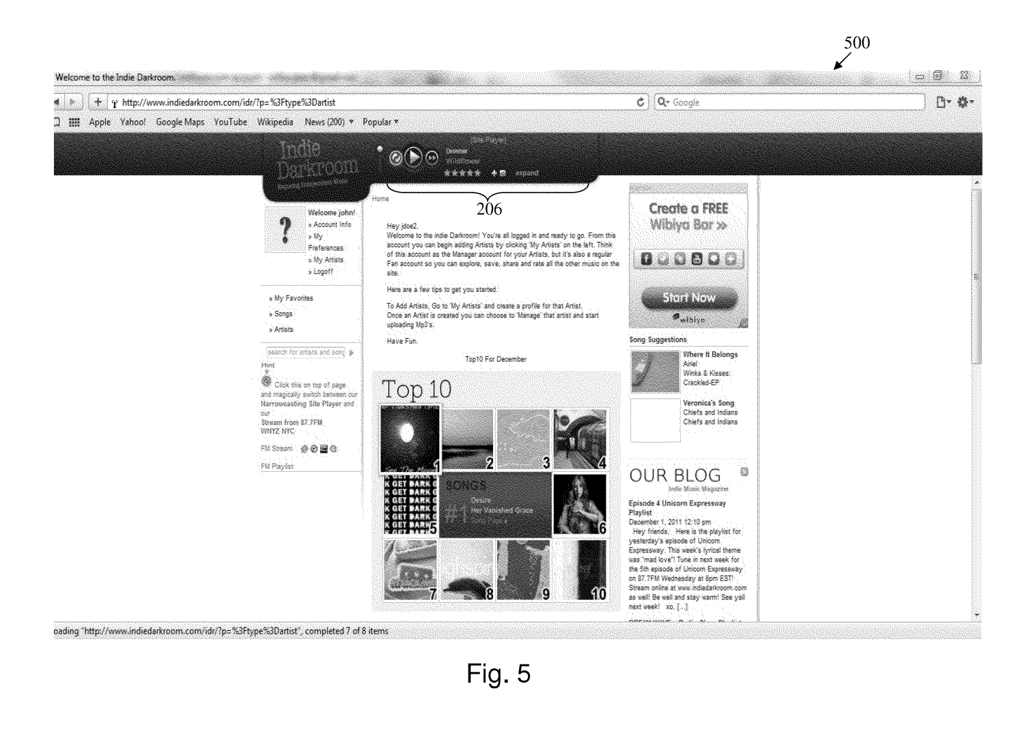

A user may also selectively supply a visual depiction or avatar that will be displayed to other users of the content distribution system. By selecting an avatar selection image element 404, a user may selectively upload an image to serve as an avatar. Additionally, the user may input a username or alias to be displayed to other users of the content distribution system using input data field 408. Secure access for each user of the content distribution system is provided by password authentication. The user may enter a secure password using password data field 410. Upon completing the sections of the fan account creation display image 400, a user may select an account creation image element which causes the control processor 102 to receive data representing the user information entered via display image 400 and automatically creates a user account record in the content creation database 108 for the user as well as generating user preference data which is linked the created user account. Upon creation of the account the content distribution system automatically generations a confirmation message that is sent to the user via email. Upon selection of a link contained within the email, the user is automatically brought back to the content distribution system via a web browsing application that is running on the user device 10 as shown in FIG. 5.

FIG. 5 is a display image 500 representing a fan page for a particular user. The fan page 500 includes similar sections as those described above with respect to FIG. 2. The difference being the log in section in FIG. 2 is replaced by the user information section 502 in FIG. 5. The user information section includes at least one link enabling further customization of the user's fan account. In addition, upon creation of a fan account a user may selective acquire content using a personalized narrow casting player that is contained within the content player section 206. The narrowcasting player automatically acquires content for the particular user from the content database using at least one content filter. A first type of content filter includes data representing at least one listening preferences. Listening preference data may be a keyword based filter that have been selected in the account settings. Listening preference data may be derived from the user selected content characteristics and content descriptors shown in FIG. 4. In one embodiment, content may be filtered by a primary keyword group corresponding to a genre in which the content may be classified. For example, if a user selects only “hip hop” from the genre keyword group, the filter will only let songs with “hip hop” in their primary keyword group be played via the player 206. If a user selects “hip hop” and “rock” as their primary keyword group, only songs classified as “hip hop” and “rock” will be played by the content player. In another embodiment, a relevancy search query is conducted on the content that matches the primary keywords. The relevancy search query further narrows the content provided to the user by finding content with as many secondary keywords matching the users specified preference keywords and provides that content to the user. A second type of content filter may include content rating data associated with content that the user has previously rated such that highly rated songs (e.g. having a greater number of stars associated therewith) will be provided for play via the narrowcasting player. A third type of filter is a global filtering parameter that is set by an administrator that adjustably filters what is allowed to be fed into the player using at least one administrative filtering parameter. The administrative filtering parameter may include any of (a) a minimum number of ratings required to enter site player and (b) a threshold quality percentage required for content to be played.

The fan page display image 500 is viewable by all users of the content distribution system and provides a homepage for the user that selectively tracks and records a user's activity as they navigate around the interactive community and the content encountered by each user. The fan page may include the username and avatar for the particular user along with a selectable message link enabling other users to send a message the particular user. The fan page may also include a section listing content identified by the user as ‘favorites’ which further include links enabling automatic access and playback by the content player 206. The fan page may also include a list of artists that the particular user has become a fan of or otherwise accessed. The list of artist may provide an automatic link to the artist page upon selection thereof. The fan page may also include a list of any comment made by the user on any piece of content stored in the content database. These comments also include links enabling a user to at least one of automatically access the page of the artist who created the content and initiate playback of the content using the content player 206. The fan page may also include a list of any comment made by the user on any artist. These comments also include links enabling a user to at least one of automatically access the page of the artist who created the content and initiate playback of the content using the content player 206. The fan page may also include a publicly available playable list generated by an artist that the particular user has followed. The artist playlist data may be selected causing the content player to acquire content listed in the playlist from the content database to be played using the content player 206. Alternatively, selection of the playlist data may be further narrowed by enabling a user to select at least one piece of content from within the playlist to be played using the content player 206.

The fan page 500 further enables the user to create playlists including content derived from the content database. Upon exploring different artist's pages and the content created thereby, a user may selectively add at least one piece of content to a content playlist that may be publicly accessible by other users or semi-private whereby the playlists are shared with a select group of users. Additionally, the content distribution system includes at least one third party social networking access application enabling a user to share their activity with others who may not be members of the content distribution system. In one embodiment, the content distribution system includes an application that allows user activity to be shared on FACEBOOK®. This activity may include playlists created by the user as well as individual content created by an artist on the site. As discussed above, all of the user interaction with any content and/or artist results in the generation of interaction point values which are continually updated for each piece of content in order to improve the rank value associated with the particular content.

In addition to each user having a fan page, certain users may also be considered content creators and therefore desire to create a content creator page. The content creator page may be an artist page that serves as a public homepage viewable by other fans and artists enabling other users to access content created by the particular artist user. The artist account includes all features discussed above with respect to fan accounts plus the additional features described below. A user may create any number of artist profiles that may be selectively administered from the core fan account page. Artist users may also selectively assign other users to be administrators for particular artist account pages thereby enabling a manager to take control of how and when the content is released as well as the manner in which the content is display to other users (e.g. fans and other artists). However, only the owner of the fan account on which the artist account was created may assign administrators and delete the artist profile.

Each artist has an artist profile page which contains data identifying and describes the artist to other users of the content distribution system. The artist profile page may include at least one of (a) an image to be associated with the artist; (b) a unique artist identification link enabling user access to the artist page; (c) a user selectable link enabling users to at least one of message an artist and comment on an artist's page; (d) biographical information describing the artist; (e) social media box providing information derived from at least one social networking site with which the artist is associated as well as providing the ability to directly comment or interact with the artists social networking site; (f) data representing comments made by other users; (g) user selectable links associated with particular content created by the artist enabling the content to be at least one of played by the content player or added to a user playlist; (h) a link enabling a user to obtain automatic updates about the artist from an artist information site (e.g. a blog); and (i) a list of the artist's fans (e.g. all fan avatars linked to their fan pages).

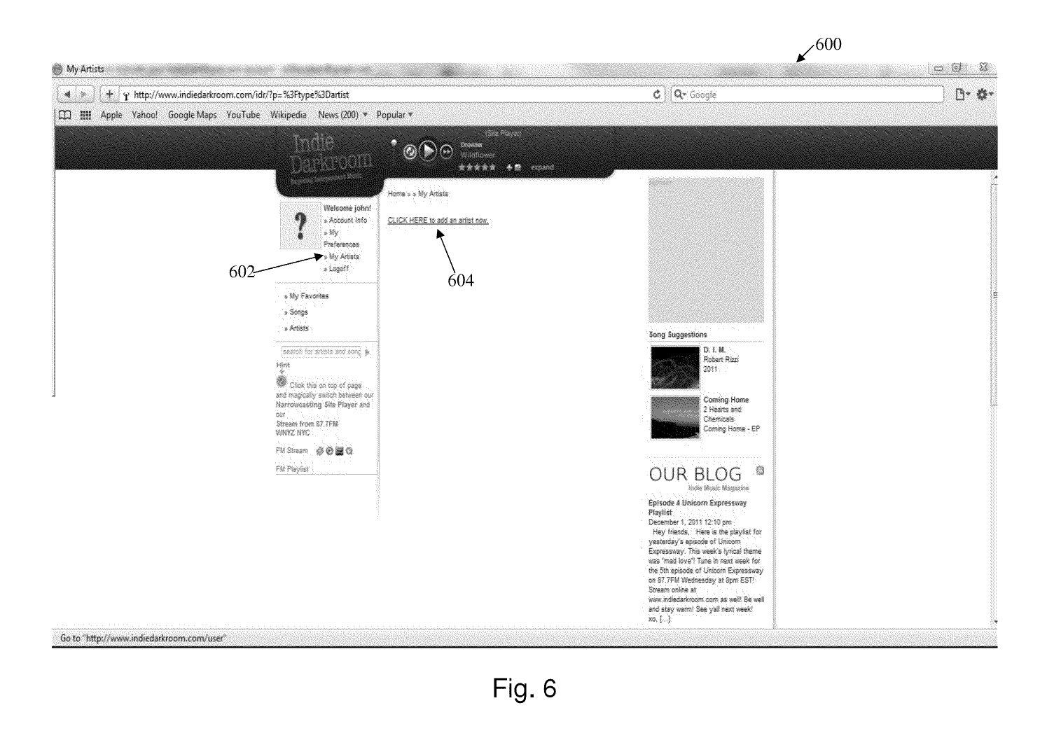

FIGS. 6-15 are exemplary display images that enable a user to create an artist account and selectively upload content that was created by the artist to the content distribution system. FIG. 6 is includes a display image 600 that enables a user to add an artist account to the previously created fan account. This feature is accessible in response to user selection of the “My Artists” link 602 which causes the control processor 102 (FIG. 1) to execute an artist creation algorithm. The artist creation algorithm includes generating a artist creation link 604 that enables the fan user to create and add an artist account that is associated with the fan account.

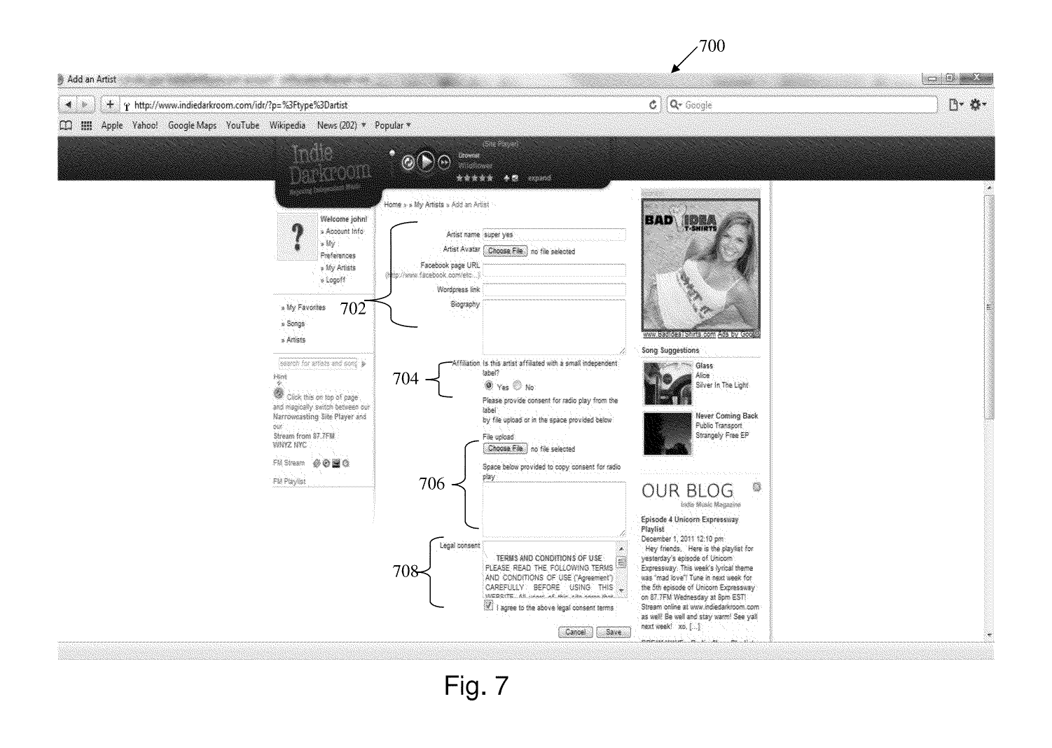

Upon selection of the artist creation link 604 in FIG. 6, the control processor 102 causes the user interface generator 104 to generate an artist page creation display image 700 as shown in FIG. 7. The artist page creation display image 700 includes an artist information section 702. The artist information section 702 enables the artist to selectively input information describing the artist as well as information that enables user to access other sources of information associated with the artist. The artist information section allows a user to enter an artist name, an avatar to be associated with the artist, biographical information describing the artist and at least one identifier enabling link access to a secondary source of information associated with the artist. The display image 700 further includes a certification section 704 enabling the artist to identify whether or not the artist is affiliated with an independent record label or is unaffiliated. A consent section 706 is provided that enables the user to grant the content distribution system to broadcast any content created by the artist via a terrestrial radio broadcast. A terms and conditions section 708 is further provided that describes all terms and conditions agreed to by the artist upon creation of the artist page and submission of any content by the artist.

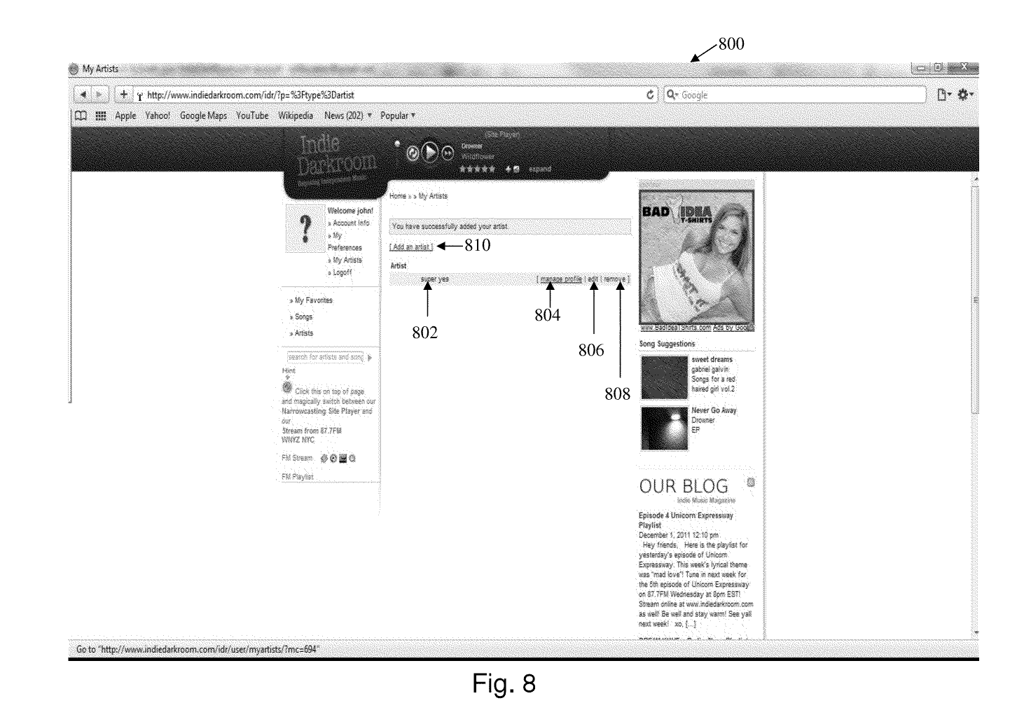

By completing all of the sections in display image 700, an artist listing display image is generated and shown in FIG. 8. The artist listing display image 800 includes at least one artist data field 802 listing the newly created artist. The artist data field 802 includes a management link 804, an editing link 806 and a removal link 808. The management link 804 enables the artist to selectively add content to be associated with the artist. The editing link 806 enables the artist to edit information associated with the artist and which was entered using the artist page creation display image of FIG. 7. The removal link 808 enables a user to selectively delete the artist page from the content distribution system. Additionally, the artist listing display image 800 includes an add artist link to selective enable re-generation of the display image shown in FIG. 7 to add an additional artist that is associated with the particular fan account.

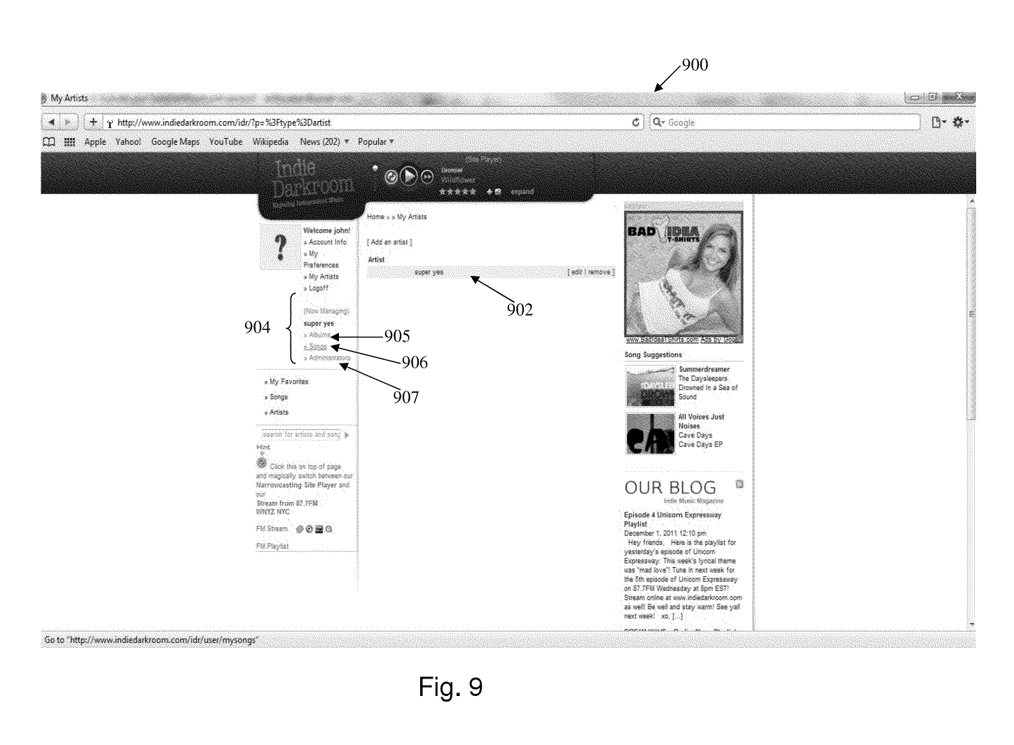

In response to selecting the management link 804 in FIG. 8, the management display image 900 as shown in FIG. 9 is automatically generated and presented to the artist user. The manage display image 900 includes artist identification information 902 that identifies the artist being managed. Additionally, the management display image 900 includes an updated management pane 904 that identifies the current artist being managed and provides links that enable the artist to provide content to the content distribution system. The management pane 904 includes an album link 905 that enables the user to upload at least one album of content. The management pane 904 also includes a song link that enables the user to upload at least one piece of content (e.g. a song created by the user). The management pane 904 also includes an administrators link 907 that selectively allows the artist to assign another user as an administrator for the artist page.

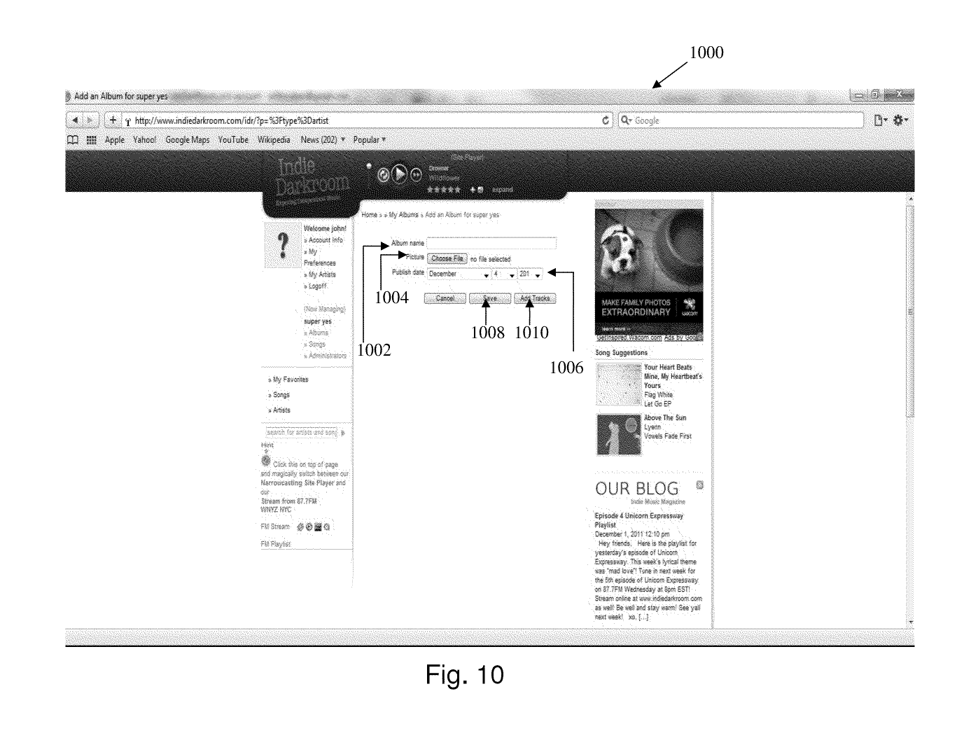

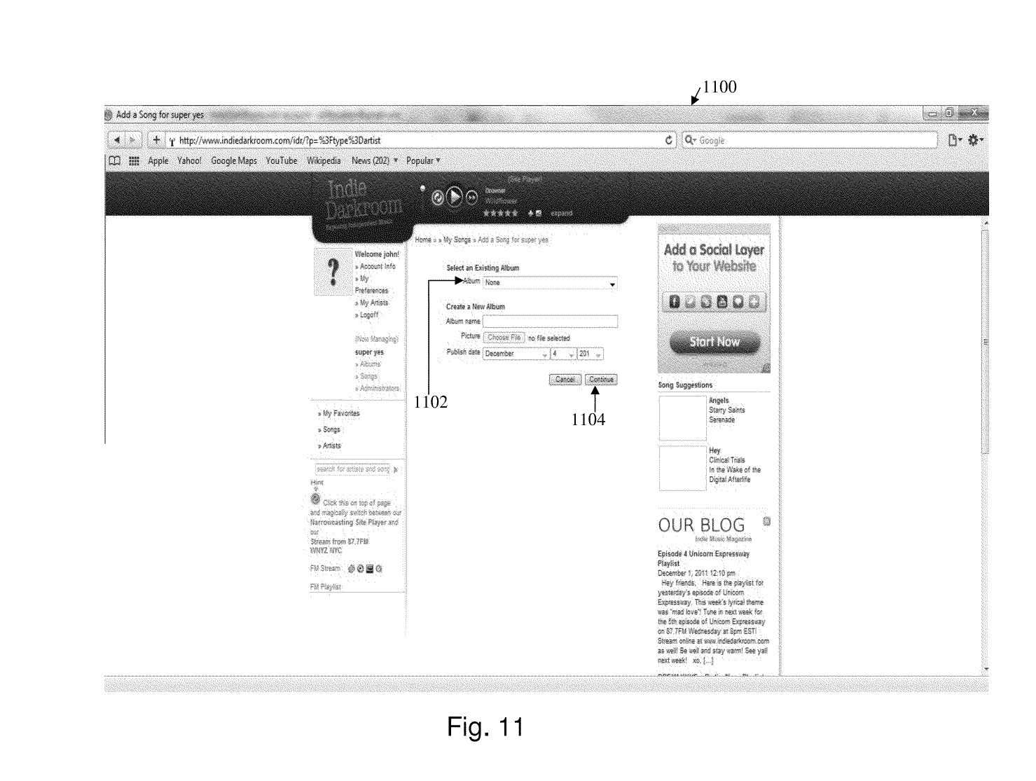

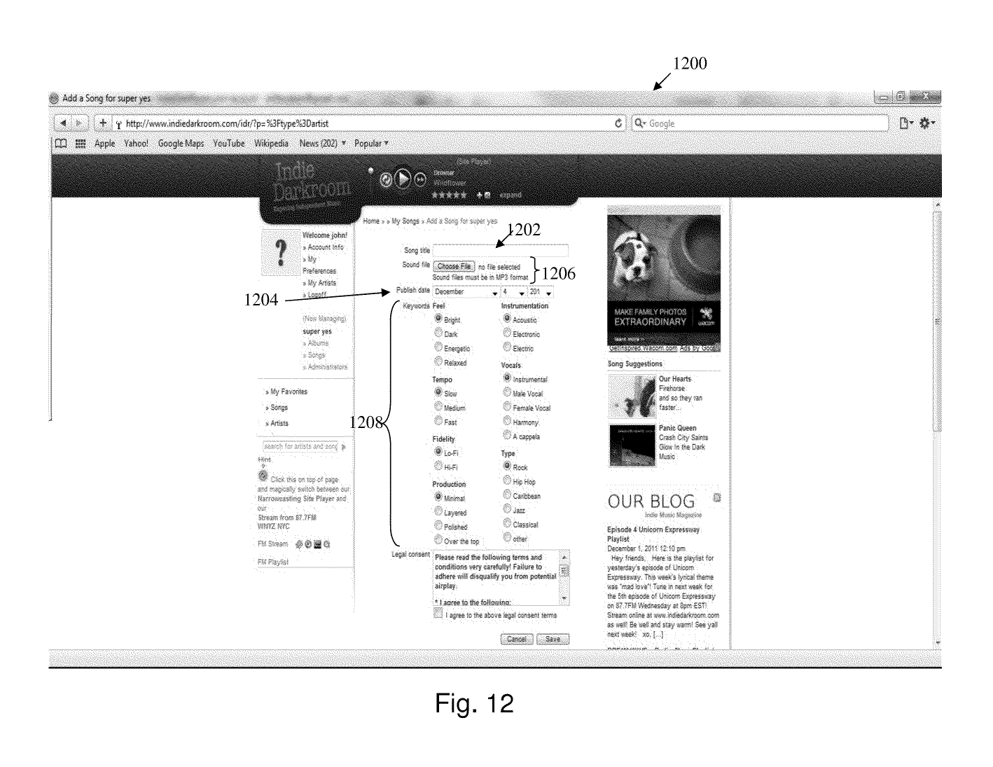

Selection of the album link 905 in FIG. 9 results in generation of an album creation display image 1000 as shown in FIG. 10. The album creation display image 1000 includes a user fillable album name data field 1002 that allows the user to selectively name the album being added. An image association element 1004 is provided that selectively enables the artist to choose and image to be uploaded and associated with the album being created. A date entry field 1006 enables the user to selectively identify the date on which the album was or will be published. Upon completing the album creation data fields 1002, 1004 and 1006, a user may select the save image element 1008 which causes a record corresponding to the album created to be saved in the content database 108 and which is associated with the particular artist. Once the album is created, the artist may select the “add tracks” image element 1010 that selectively enables the user to populate the newly created album with at least one piece of content. Selection of the add tracks image element 1010 results in generation of a content association display image 1100 as shown in FIG. 11 that allows a user to associate a piece of content being added with a particular album using the album association data field. Alternatively, if no album association is to be provided, the user may select the “continue” image element 1104 which results in the content submission display image 1200 as shown in FIG. 12.

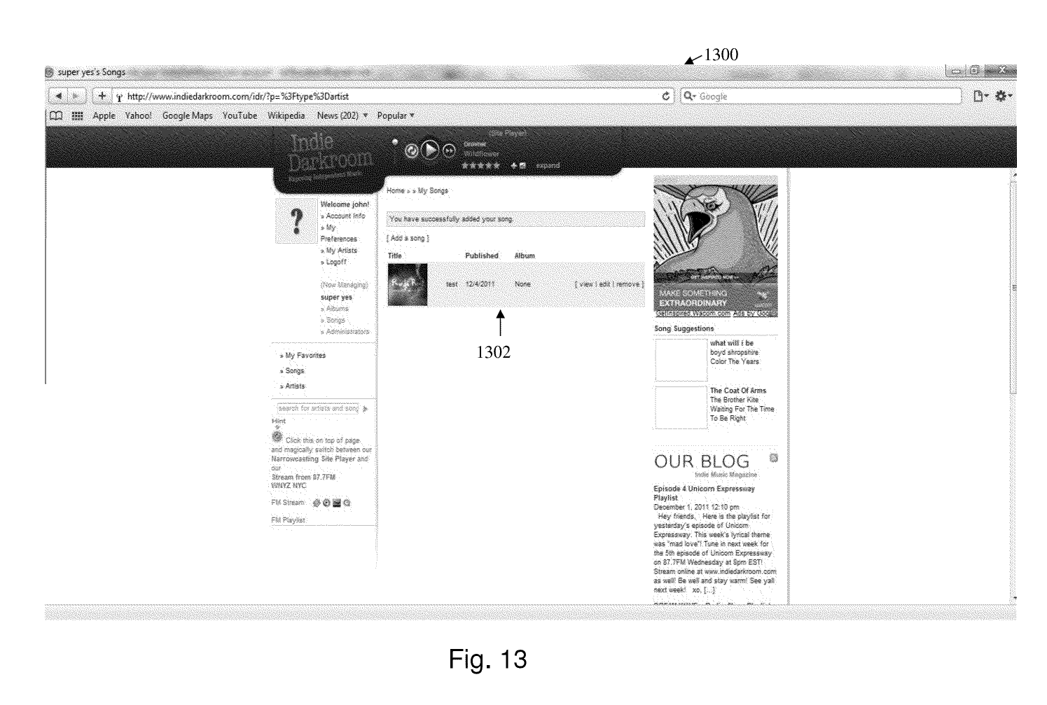

The content submission display image 1200 in FIG. 12 includes a content title field 1202 that enables the user to selectively add a title for the content being submitted and a content date field 1204 that allows the artist to identify the date on which the content was published or will be published. The content is selected from a user content source by selecting a content source image element 1206 that allows the user to specify a location on a user device at which the content being provided is located. The content submission page further includes a content characteristic section 1208 that includes at least one content characteristic and at least one content descriptor that is associated with the at least one content characteristic. This section 1208 is similar to the user preferences section described above in FIG. 4. These characteristics advantageously enable the artist to characterize the content in a particular manner. Once characterized the content characteristic information will be used to filter the content according to user preferences that match corresponding content characteristic information. Upon completion and uploading of the content using the content submission display image 1200, an artist content display image 1300 as shown in FIG. 13 is generated by the system and presented to the user. The content display image 1300 includes at least one content data field 1302 corresponding to the content uploaded and submitted by the artist.

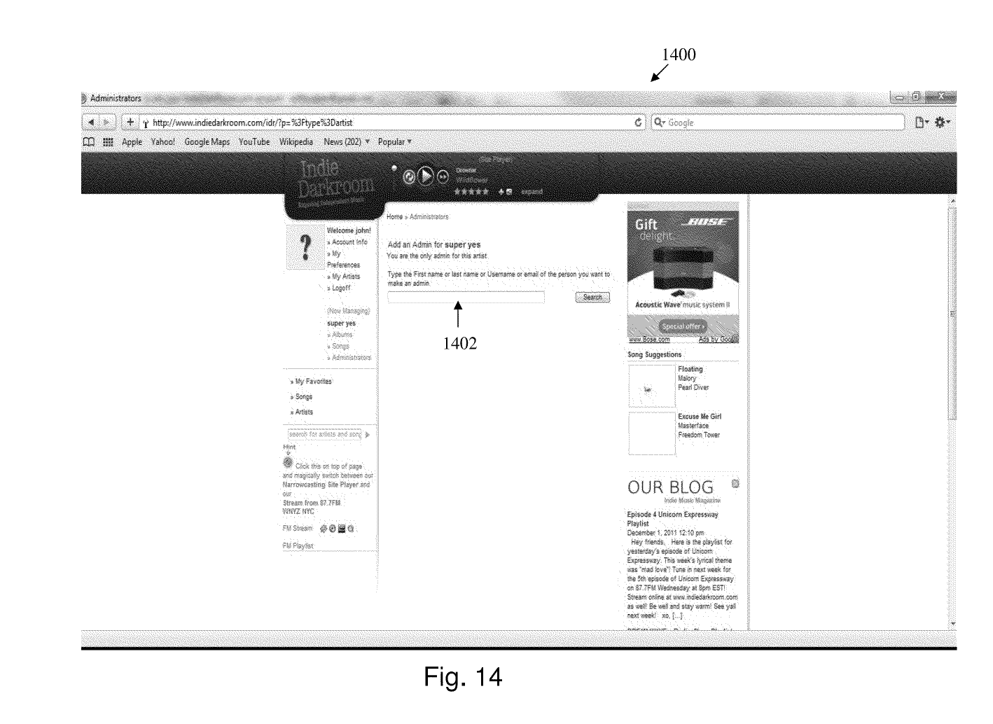

Referring back to FIG. 9, in response to selection of the administration link 907, an administration display image 1400 as shown in FIG. 14 is generated. The administration display image 1400 includes an administration assignment data field 1402 that selectively allows an artist to identify another user of the content distribution system to be an administrator for the artist's page. Assigning administration rights enables the assigned user to selectively add and remove content that is associated with the artist as well as edit information about the artist which is publicly available to other users.

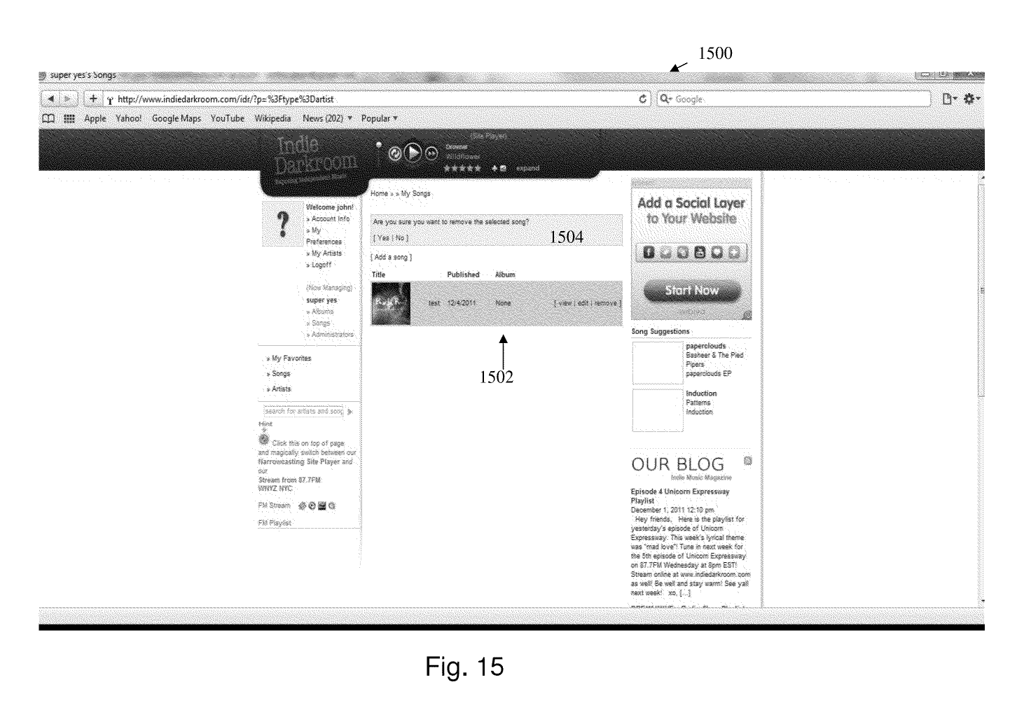

FIG. 15 is an exemplary display image that allows an artist user to selectively remove a piece of content that is currently associated with the artist. As shown in FIG. 15, the display image includes a content identification section 1501 that identifies content currently associated with the artist. The content identification section 1501 includes a removal link 1502 that, upon selection thereof, causes the control processor purge the content database of the content listed in section 1501. Prior to actually purging the content from the system, a confirmation window 1504 is generated and presented to the user to confirm removal of the content. Upon confirmation using the confirmation window, the content identified in section 1501 is automatically and permanently deleted from the content distribution system.

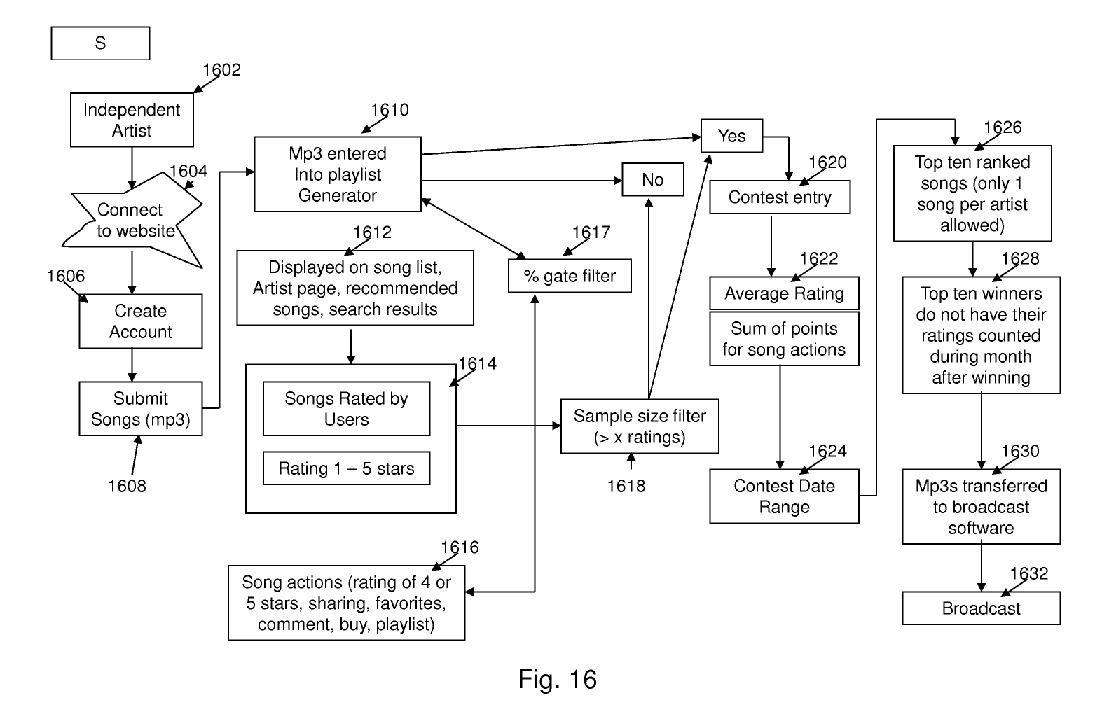

An exemplary operation of the content distribution system will now be described in FIG. 16. In block 1602 an independent artist connects to the content distribution system via a web accessible portal shown in block 1604. The independent artist and/or fans create an account in block 1606. The account creation may occur in accordance with the description of FIGS. 4-15 discussed hereinabove. The artist user may selectively submit at least one piece of content (e.g. a song) to the content distribution system in block 1608. The content submitted is characterized and entered in a playlist generator that generates at least one playlist to be played by a content player on the site as shown in block 1610. Once a song is uploaded to the site, it is placed in our song database. Once in the database it is available for inclusion on the site player. The songs are provided to users via the content player based on query filters corresponding to user preferences as shown in block 1612. Songs played via the content player may be selectively assigned a rank value using a ranking image element to assign a numerical rank value corresponding to a number of stars selected by a user as shown in block 1614. The numerical rank assigned to the song is a primary ranking criteria. Additionally, user interaction with particular songs generates interaction point values associated with the particular song as shown in block 1616. Exemplary interaction point values are generated by at least one of commenting on a song, putting a song in favorites list, purchasing a song, putting a song on a playlist. The sum of the interaction point values may be used as a secondary ranking criteria to determine a songs rank. In one embodiment, the secondary ranking criteria may be used to break a tie if songs a rated the same using the primary ranking criteria thereby have the same average rating score. The songs ranked using the primary and secondary ranking criteria are filtered using a percentage gate filter in block 1617. The percentage gate filter only lets songs with average rating score above a threshold value into the playlist generator in block 1610. The threshold value is an adjustable parameter set by the site administrator that sets a minimum rating level that must be maintained by a piece of content prior to inclusion within the playlist generator of block 1610.

Referring back to block 1614, upon ranking the songs using the primary ranking criteria, the system filters the content using a sample size filter in block 1618. The sample size filter is a parameter set by administrator that identifies a number of rankings a song must receive from unique users before being able to be selected as highly rated song that may be provided for broadcast. If the result of the sample size filter is that the song has not received enough rankings, the song is provided back to the playlist generator for inclusion in site playlist being provided to users thereby enabling the song to obtain the additional rankings needed for consideration as part of the broadcast rotation.

If the sample size filter in block 1618 determines that the song has been ranked a sufficient number of times, the song is provided to a group of songs that are in the running to be included within the broadcast rotation in block 1620. This may take the form of contest between a select group of songs to determine a subset of the select group that will be included within a broadcast rotation of a terrestrial radio station. Upon entry into the contest in block 1620, the songs are ranked by averaging the ratings associated with each song and generating an ordered list of ranked songs organized highest to lowest according to average rank value. If certain songs have the same average rank value, interaction points associated with the songs may be used by the system to determine the final order in block 1622. This comparison and ranking of selected songs is performed over a predetermined period of time as shown in block 1624. Thus, the ratings and interaction points are only counted within the predetermined period of time. Based on average ratings and song action points within the predetermined period of time, a set of songs corresponding to the highest ranked songs are selected and reviewed to ensure compliance with governmental regulations in block 1626. Upon selection as one of the highest ranking songs, the system automatically marks the song to be removed from the set of songs able to compete in the contest for a subsequent time period as shown in block 1628. Thus, the ratings for the winning songs are not counted for the month they are heavily broadcast because heavy broadcasting of these songs which advantageously enables the winning songs to receive the extra heavy promotion. By marking these songs as ineligible for the subsequent contest, these songs that are on heavy broadcast rotation are effectively removed for the group of songs able to be included in future broadcast rotation and gives other songs a chance to win the contest and earn the extra promotion. Data representing the winning songs are transmitted to the broadcaster in block 1630 and the songs are broadcast via terrestrial radio broadcast in block 1632.

The system and method described above with respect to FIG. 1-16 advantageously provides content creators with an avenue to achieve traditional distribution of their content without the need to be associated with a major content distribution partner. The system advantageously enables users to selectively access and rate independently created content and selectively determine which content may be broadcast via a traditional broadcast medium such as terrestrial radio station. The system includes a plurality of checks to ensure a democratic selection of content to be included within a broadcast rotation for a particular time frame. The system further advantageously ensures that not only a single content creator will be selected for and dominate the broadcast rotation by advantageously removing content that has previously been selected for broadcast from the group of content being ranked during subsequent time periods. Additionally, the system provides a wholly interactive community that enables fans and artists to commune with one another allowing the fan to be exposed to content that would typically be unavailable while enabling the content creator to have their work sampled and reviewed and potentially broadcasted and exposed to other people who are not users of the system. This enhanced exposure by conventional broadcasting medium would not be available to these content creators without the present system.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

We claim:

1. A system that selects content data from a set of content data for broadcast, the system comprising:
a content database that stores the set of content data therein, the set of content data including a plurality of content data files, each of the respective content data files being provided by a respective user;
a communication interface that receives ranking data from users for content data files within the set of content data;
a control processor coupled to the communication interface that generates an aggregate content rank for each of the content data files based on the ranking data received by the communication interface and selects a subset of content data files from the content database having the greatest aggregate content rank for inclusion in a broadcast playlist; and
a broadcaster that broadcasts the subset of content data files in the broadcast playlist based on the aggregate content rank.

2. The system according to claim 1, wherein
the control processor generates the aggregate content rank for each respective content data file based on the ranking data received from user by the communication interface over a predetermined period of time.

3. The system according to claim 2, wherein
the predetermined period of time for generating aggregate content rank is at least one of (a) weekly; (b) bi-weekly and (c) monthly.

4. The system according to claim 2, wherein
the control processor generates the content trend rank using aggregate content rank data associated with a plurality of different predetermined time periods.

5. The system according to claim 1, wherein
the ranking data includes a primary rank that is selectively assignable once during a predetermined time period.

6. The system according to claim 1, wherein
the ranking data includes a numerical scaled rank that is selectively entered by a user via a user interface device.

7. The system according to claim 1, wherein
the ranking data includes content interaction ranking information indicative of user interaction with respective content data file.

8. The system according to claim 7, wherein
content interaction ranking information includes a positive interaction indicator, the positive interaction indicator indicating that at least one user has at least one of (a) rated the content; (b) marked a content as favorite; (c) shared the content with at least one other user; (d) shared the content on a social networking site; (e) linked to the content on a page accessible to other users; (f) purchased the content; and (g) provided a positive comment on the content.

9. The system according to claim 8, wherein
content interaction ranking information includes a negative interaction indicator, the negative interaction indicator indicating that at least one user has at least one of (a) decreased a previously entered rating associated with the content; (b) removed the content from a favorites list; (c) unlinked content from a page accessible to other users; and (d) providing a negative comment about the content.

10. The system according to claim 9, wherein
the control processor modifies ranking data associated with respective content data file based on the content interaction ranking information by one of (a)incrementing a numerical rank value associated with the respective content data file in response to a positive interaction indicator or (b) decrementing a numerical rank value associated with the respective content data file in response to a negative interaction indicator.

11. The system according to claim 1, wherein
the control processor selects respective content data files for inclusion in the broadcast playlist upon receipt, by the communication interface, of a predetermined minimum amount of ranking data representing a rank for the respective content data file.

12. The system according to claim 1, further comprising
a user interface generator coupled to the control processor and the communication interface that generates a user interface display image enabling user interaction with the system for display on a user interface device.

13. The system according to claim 12, wherein
the user interface display image includes at least one respective content data file from the set of content data file and a plurality of user selectable image elements enabling a user to enter ranking data to be associated with the at least one respective content data file.

14. The system according to claim 12, wherein
the user device includes at least one of (a) a computer; (b) a smart phone; (c) a tablet; (d) a mobile phone; and (e) an internet connected terminal.

15. The system according to claim 12, wherein
the user interface display image includes data identifying the respective content data file and at least one field enabling input of data representing a characteristic associated with the at least one respective content data file.

16. The system according to claim 15, wherein
the control processor modifies the aggregate content rank associated with the respective content data file in response to receipt of data representing a characteristic.

17. A method of selecting content data from a set of content data for broadcast, the method including the activities of:
storing, in a content database, a plurality of content data files as a set of content data files, each of the respective content data files being provided by a respective user;
receiving, via a communication interface, ranking data from users for content data files within the set of content data;
generating, via a control processor, an aggregate content rank for each of the content data files based on the ranking data received by the communication interface;
selecting a subset of content data files from the content database having the greatest aggregate content rank for inclusion in a broadcast playlist; and
broadcasting the subset of content data files in the broadcast playlist based on the aggregate content rank.

18. The method according to claim 17, wherein the activity of generating further includes
generating the aggregate content rank for each respective content data file based on the ranking data received from user by the communication interface over a predetermined period of time, the predetermined period of time for generating aggregate content rank is at least one of (a) weekly; (b) bi-weekly and (c) monthly.

19. The method according to claim 17, wherein the activity of generating further includes
generating a content trend rank using aggregate content rank data associated with a plurality of different predetermined time periods.

20. The method according to claim 17, the activity of receiving further includes
receiving the ranking data once during a predetermined time period.

21. The method according to claim 17, wherein the activity of receiving further includes
receiving ranking data including content interaction ranking information indicative of user interaction with respective content data file.

22. The method according to claim 21, wherein
content interaction ranking information includes a positive interaction indicator, the positive interaction indicator indicating that at least one user has at least one of (a) rated the content; (b) marked a content as favorite; (c) shared the content with at least one other user; (d) shared the content on a social networking site; (e) linked to the content on a page accessible to other users; (f) purchased the content; and (g) provided a positive comment on the content.

23. The method according to claim 22, wherein
content interaction ranking information includes a negative interaction indicator, the negative interaction indicator indicating that at least one user has at least one of (a) decreased a previously entered rating associated with the content; (b) removed the content from a favorites list; and (c) unlinked content from a page accessible to other users.

24. The method according to claim 23, further comprising the activity of
modifying ranking data associated with respective content data file based on the content interaction ranking information by one of (a)incrementing a numerical rank value associated with the respective content data file in response to a positive interaction indicator or (b) decrementing a numerical rank value associated with the respective content data file in response to a negative interaction indicator.

25. The method according to claim 17, wherein the activity of selecting further includes
selecting respective content data files for inclusion in the broadcast playlist upon receipt, by the communication interface, of a predetermined minimum amount of ranking data representing a rank for the respective content data file.

26. The method according to claim 1, further comprising the activity of
generating, via a user interface generator coupled to the control processor and the communication interface, a user interface display image enabling user interaction with the system for display on a user interface device.

27. The method according to claim 26, wherein
the user interface display image includes at least one respective content data file from the set of content data file and a plurality of user selectable image elements enabling a user to enter ranking data to be associated with the at least one respective content data file.

28. The method according to claim 26, wherein
the user device includes at least one of (a) a computer; (b) a smart phone; (c) a tablet; (d) a mobile phone; and (e) an internet connected terminal.

29. The method according to claim 26, wherein the activity of generating includes
generating a user interface display image including data identifying the respective content data file and at least one field enabling input of data representing a characteristic associated with the at least one respective content data file.

30. The method according to claim 29, further comprising the activity of
modifying, by the control processor modifies, the aggregate content rank associated with the respective content data file in response to receipt of data representing a characteristic.
